(19) United States
(12) Patent Application Publication
(10) Pub. No.: US 2025/0211157 A1
(43) Pub. Date: Jun. 26, 2025

(54) OPENING/CLOSING BODY CONTROL DEVICE

(71) Applicant: U-SHIN LTD., NAGANO (JP)

(72) Inventors: Masayuki NAKANISHI, Hiroshima (JP); Keisuke MYOTOKU, Hiroshima (JP)

(21) Appl. No.: 18/985,375

(22) Filed: Dec. 18, 2024

(30) Foreign Application Priority Data
Dec. 26, 2023 (JP) 2023-219706

(51) Int. Cl. H02P 29/00; B60J 5/10; G01P 3/481

(52) U.S. Cl. CPC H02P 29/00; B60J 5/101; G01P 3/481; H02P 2205/07

(57) ABSTRACT

An opening/closing body control device includes: a rotation sensor that outputs a first pulse signal and a second pulse signal having a phase difference from the first pulse signal; an edge detection unit detects a pulse edge of the pulse signal; a speed update unit that measures and updates an opening/closing speed on the basis of a pulse signal at a predetermined update timing; and a motor control unit controls the motor according to the updated opening/closing speed. The speed update unit executes two-pulse update processing of setting, as the update timing, the timing at which at least one of a first rising edge and a first falling edge is detected and the timing at which at least one of a second rising edge and a second falling edge is detected.

### CROSS REFERENCE TO RELATED APPLICATION

This application claims benefit of priority to Japanese Patent Application No. 2023-219706 filed on Dec. 26, 2023, the entire content of which is incorporated herein by reference.

### TECHNICAL FIELD

The present invention relates to an opening/closing body control device.

### BACKGROUND ART

JP H11-343773 A discloses a control device that performs feedback control of an opening/closing speed of a vehicle slide door driven by a motor. The control device inputs a revolution pulse signal of the motor, measures a rotation pulse cycle of the motor, and controls the motor according to a measurement result. The pulse cycle can be converted into an opening/closing speed. The opening/closing speed of the slide door changes between a full open state and a full close state. At high speeds, the pulse cycle is measured in sync with the rising edge of a revolution pulse signal. At low speeds, the pulse cycle is measured in sync with both the rising edge and the falling edge of the revolution pulse signal, thereby maintaining the measurement frequency and thus the control accuracy.

### SUMMARY

There is still room for improvement in the control accuracy of the opening/closing speed of the opening/closing body.

An object of the present invention is to improve control accuracy of an opening/closing speed of an opening/closing body.

One aspect of the present invention is an opening/closing body control device that controls an operation of an opening/closing body that opens and closes an opening of a vehicle body, the opening/closing body control device including: a motor that outputs a rotational driving force for driving the opening/closing body; a rotation sensor that outputs a first pulse signal and a second pulse signal having a phase difference from the first pulse signal at a cycle corresponding to rotation of the motor; an edge detection unit that detects a first rising edge and a first falling edge of the first pulse signal and a second rising edge and a second falling edge of the second pulse signal as pulse edges of the pulse signals; a speed update unit that measures and updates an opening/closing speed of the opening/closing body based on at least one of the first pulse signal and the second pulse signal at a predetermined update timing; and a motor control unit that controls the motor according to the updated opening/closing speed, in which the speed update unit executes two-pulse update processing of setting, as the update timing, a timing at which at least one of the first rising edge and the first falling edge is detected and a timing at which at least one of the second rising edge and the second falling edge is detected.

According to the above configuration, the rotation sensor can output the first pulse signal and the second pulse signal having the phase difference, and the opening/closing body control device can execute the two-pulse update processing. In the two-pulse update processing, the update timing for measuring and updating the opening/closing speed is synchronized with the detection timing of the pulse edge of the first pulse signal and the detection timing of the pulse edge of the second pulse signal. Compared to a case where the opening/closing speed is updated in sync with only the pulse edge of the single pulse signal, the measurement frequency of the opening/closing speed and the control accuracy are improved.

According to the present invention, the control accuracy of the opening/closing speed of the opening/closing body can be improved.

### BRIEF DESCRIPTION OF DRAWINGS

FIG. 1 is a perspective view illustrating a part of a vehicle to which an opening/closing body control device according to an embodiment is applied;

FIG. 2 is a block diagram illustrating an opening/closing body control device according to the embodiment;

FIG. 3 is a schematic diagram of a motor and a rotation sensor;

FIG. 4 is a view taken along an arrow IV-IV in FIG. 3;

FIG. 5 is an explanatory diagram of a phase difference and an arrangement angle difference;

FIG. 6A is a waveform diagram of a first pulse signal and a second pulse signal;

FIG. 6B is a waveform diagram of a first pulse signal and a second pulse signal;

FIG. 7 is a graph showing a temporal change in opening/closing speed;

FIG. 8 is a flowchart showing processing executed by a controller;

FIG. 9 is a flowchart showing high-speed update processing executed by a controller;

FIG. 10 is a flowchart illustrating low-speed update processing executed by the controller according to a first embodiment;

FIG. 11 is a waveform diagram of a pulse signal during execution of the high-speed update processing;

FIG. 12 is a waveform diagram of a pulse signal during execution of the low-speed update processing according to the first embodiment;

FIG. 13 is a flowchart showing low-speed update processing according to a modification;

FIG. 14 is a flowchart showing low-speed update processing according to a second embodiment;

FIG. 15 is a waveform diagram of a pulse signal during execution of the low-speed update processing according to the second embodiment; and

FIG. 16 is a diagram illustrating an example of placement of a rotation sensor.

### DETAILED DESCRIPTION

Hereinafter, embodiments of the present invention are described with reference to the drawings. Note that the same or corresponding elements are denoted by the same reference numerals throughout the drawings, and overlapping of detailed description will be omitted.

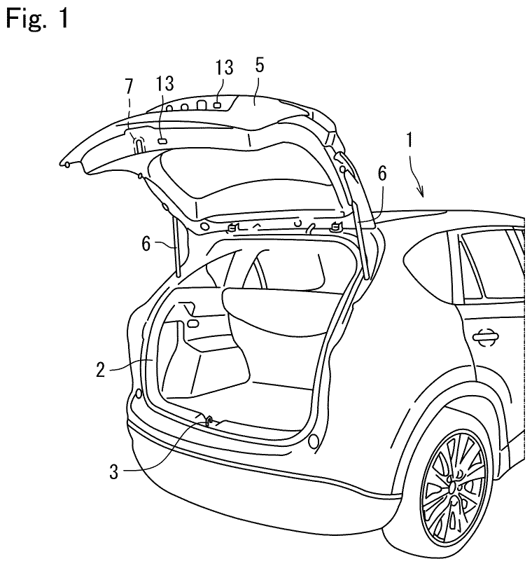

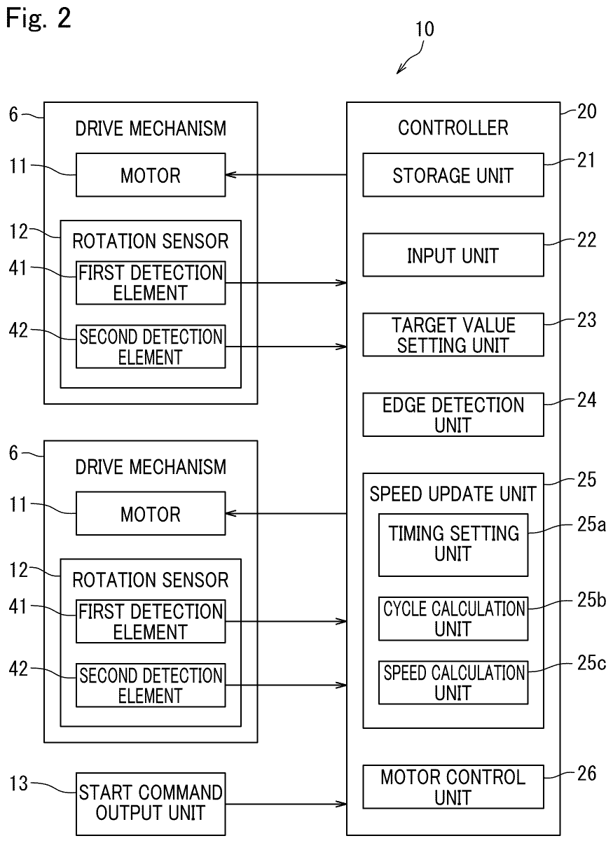

FIG. 1 illustrates a part of a vehicle to which an opening/closing body control device 10 (see FIG. 2) according to an embodiment is applied. An opening/closing body control device 10 controls an operation of an opening/closing body 5 that opens and closes an opening 2 of a vehicle body 1. The opening/closing body 5 is attached to the vehicle body 1 so as to be displaceable between a full close position where the opening 2 is fully close and a full open position where the opening 2 is fully opened. The operation of the opening/closing body 5 includes an opening operation of displacing toward the full open position and a closing operation of displacing toward the full close position. The opening/closing body 5 is driven by a drive mechanism 6 including a motor 11 (see FIG. 2).

For example, the opening 2 is provided at the rear portion of the vehicle body 1 to open the passenger compartment or the cargo compartment, the opening/closing body 5 is a back door, and the drive mechanism 6 is a pair of spindle drive mechanisms provided in the vehicle width direction. The back door is rotatably attached to the vehicle body 1 by hinge connection, and its rotation axis extends in the vehicle width direction at the upper edge of the opening 2. Each spindle drive mechanism is configured as a rod body that expands and contracts according to the rotation direction of the motor 11 (see FIG. 2), and has one end portion pivotally supported by the vehicle body 1 and the other end portion pivotally supported by the opening/closing body 5. The opening/closing body 5 performs an opening operation according to extension of the rod body and performs a closing operation according to contraction of the rod body.

The opening/closing body 5 is provided with a latch mechanism 7 that detachably holds the striker 3 provided in the vehicle body 1. By the action of the latch mechanism 7, the opening/closing body 5 can be held at the full close position.

Referring to FIG. 2, the opening/closing body control device 10 includes a rotation sensor 12, a start command output unit 13, and a controller 20 in addition to the motor 11 described above. The opening/closing body control device 10 may include a motor that drives the latch mechanism 7 and a sensor that detects the state of the latch mechanism 7.

In the present embodiment, a pair of drive mechanisms 6 is used to drive one opening/closing body 5. Each drive mechanism 6 has a set of one motor 11 and one rotation sensor 12. Since the two sets are configured similarly to each other, only one set will be described. Note that only one of the pair of drive mechanisms 6 may have a set of the motor 11 and the rotation sensor 12. In this case, the other drive mechanism 6 does not have a set of the motor 11 and the rotation sensor 12, and is driven by the motor 11 of the one drive mechanism 6.

The start command output unit 13 outputs a command to start the operation of the opening/closing body 5 according to the operation of the user. The start command output unit 13 may be configured by a button type switch attached to the opening/closing body 5 or the passenger compartment and manually operated by the user. The start command output unit 13 may be configured by a button type switch which is mounted on an electronic key and is manually operated by a user. The electronic key is carried by the user and is configured to be able to wirelessly communicate with the controller 20. The start command output unit 13 may be configured by a human sensor (For example, an infrared sensor, a capacitance sensor, or the like) that is provided in the opening/closing body 5 or the vehicle body 1 in the vicinity thereof and detects contact or approach of a user. The user's operation includes an action of intentionally causing a part of the body (For example, a fingertip or a toe) to enter the detection range of the human sensor.

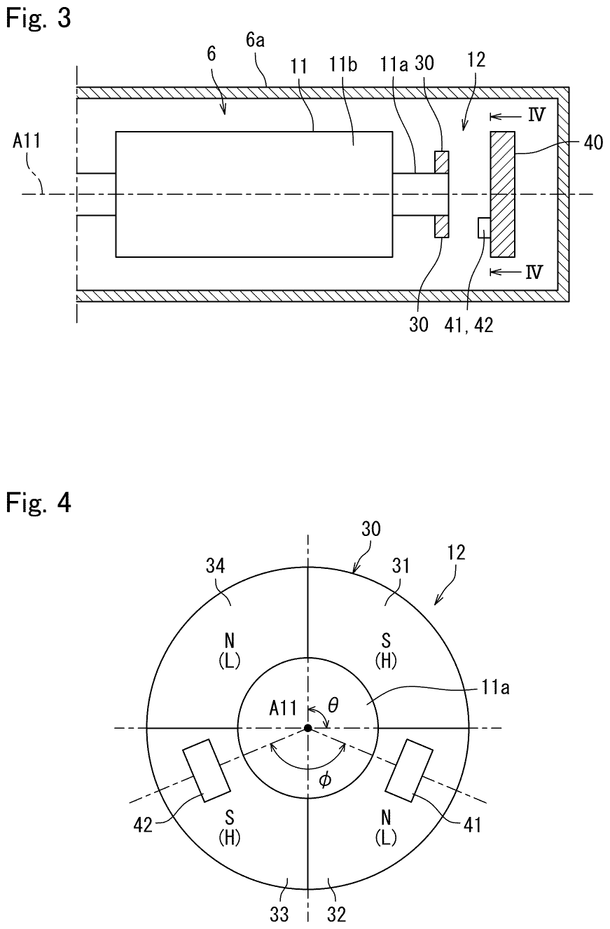

Referring to FIG. 3, a set of the motor 11 and the rotation sensor 12 is incorporated in the housing member 6a of the drive mechanism 6. The output shaft 11a of the motor 11 is supported by the housing member 6a so as to be rotatable in both directions around the central axis A11. The output shaft 11a protrudes from the housing 11b of the motor 11 to both sides in the axial direction (the lateral direction in FIG. 3). On one side (left side in FIG. 3) in the axial direction as viewed from the housing 11b, the output shaft 11a outputs a rotational driving force for driving the opening/closing body 5. On the other side in the axial direction (right side in FIG. 3) as viewed from the housing 11b, a part of the rotation sensor 12 is attached to the output shaft 11a.

Referring to FIGS. 3 and 4, the rotation sensor 12 includes an object to be detected 30 fixed to the output shaft 11a, a circuit board 40 fixed to the housing member 6a of the drive mechanism 6, and a first detection element 41 and a second detection element 42 mounted on the circuit board 40.

The object to be detected 30 is configured by a ring-shaped permanent magnet fixed to the outer peripheral surface of the other end portion of the output shaft 11a, and rotates integrally with the output shaft 11a. The plurality of magnetic poles 31-34 are arranged at equal angles around the central axis A11, and the N poles and the S poles are alternately arranged in the circumferential direction. Each magnetic pole 31-34 has a partial annular shape when viewed in the axial direction, and the central angles θ thereof are equal to each other. The central angle θ is a value obtained by dividing 360 degrees by the number of poles P (θ=360°/P). The number of poles P is an even number because of the alternate arrangement of the N poles and the S poles. The number p of pairs of the N pole and the S pole is a half of the number P of poles (p=½ P). For example, when the number of poles P is 4, the number of pairs p is 2 and the central angle θ is 90 degrees.

The circuit board 40 is disposed on the other side (right side in FIG. 3) in the axial direction of the output shaft 11a, and is slightly separated from the output shaft 11a in the axial direction. The surface of the circuit board 40 is substantially orthogonal to the axial direction and is directed to one side (left side in FIG. 3) in the axial direction. The first detection element 41 and the second detection element 42 are mounted on the surface at positions separated from the central axis A11 in the radial direction, and face the object to be detected 30 in the axial direction. Both the first detection element 41 and the second detection element 42 are Hall ICs.

While the output shaft 11a is rotating, the first detection element 41 outputs a low-level L signal when facing the N pole, and outputs a high-level H signal when facing the S pole. The first detection element 41 outputs the first pulse signal by switching the signal level by the same number as the number of poles P while the motor 11 makes one rotation. Similarly to the first detection element 41, the second detection element 42 also outputs a second pulse signal. Hereinafter, when the first pulse signal and the second pulse signal are described without distinction, they are simply referred to as “pulse signals”.

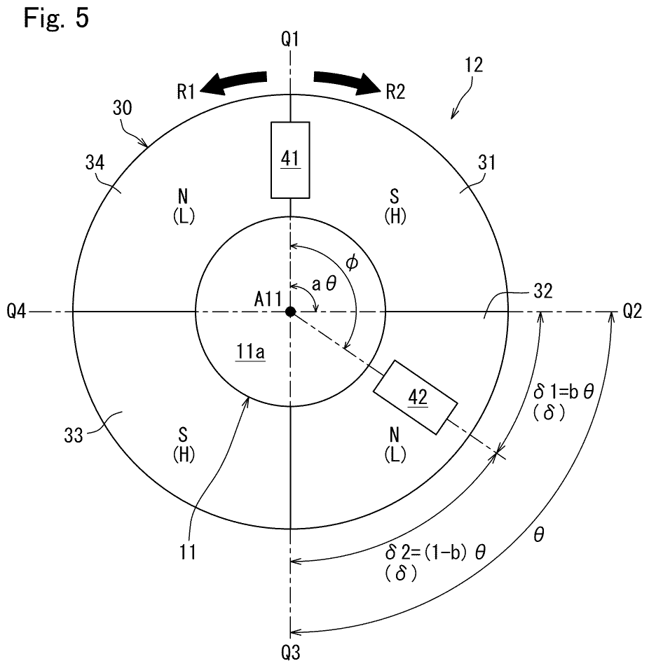

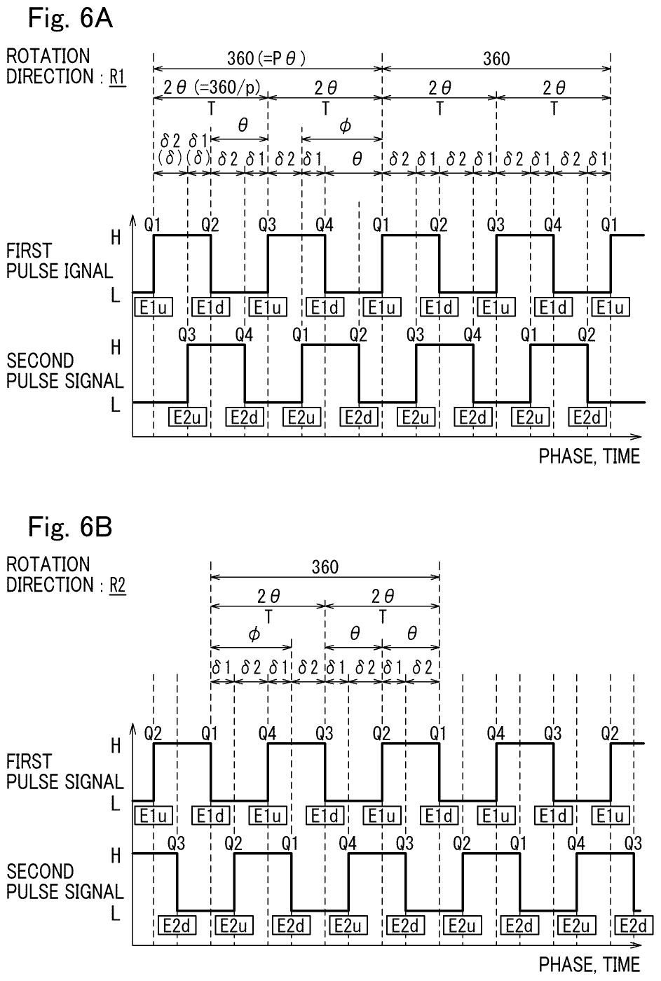

As illustrated in FIGS. 6A and 6B, the pulse signal is a rectangular wave, and includes a pulse edge that appears at the timing when the signal level is switched. The pulse edge is generated when the magnetic pole boundaries Q1 to Q4 (see also FIG. 5) pass through the detection element. The pulse edge includes a rising edge indicating switching from the low level L to the high level H and a falling edge indicating switching from the high level H to the low level L. In one pulse signal, the rising edge and the falling edge alternately appear each time the motor 11 and the object to be detected 30 rotate by the rotation angle corresponding to the central angle θ.

Hereinafter, the pulse edge of the first pulse signal is referred to as a “first pulse edge”, the rising edge of the first pulse signal is referred to as a “first rising edge E1u”, and the falling edge of the first pulse signal is referred to as a “first falling edge E1d”. The pulse edge of the second pulse signal is referred to as a “second pulse edge”, the rising edge of the second pulse signal is referred to as a “second rising edge E2u”, and the falling edge of the second pulse signal is referred to as a “second falling edge E2d”.

The rotation sensor 12 outputs two pulse signals of a first pulse signal and a second pulse signal at a cycle T corresponding to the rotation (More specifically, the rotation angle and the rotation speed) of the motor 11. The “cycle” of the pulse signal is a time interval between two adjacent rising edges or between two adjacent falling edges in the first pulse signal or the second pulse signal. In other words, the cycle T is a time elapsed while the motor 11 rotates by a rotation angle corresponding to a double value of the central angle θ, that is, a value obtained by dividing 360 degrees by the number of pairs p (2θ=360°/p). The number of pairs p is the number of cycles corresponding to one rotation of the motor 11. When the number of poles P is 4, 2 of the number of pairs p is the number of cycles corresponding to one rotation of the motor 11.

The second pulse signal has a phase difference δ from the first pulse signal. In the present specification, “having the phase difference δ” means that the timing at which the pulse edge appears is shifted between the first pulse signal and the second pulse signal. Therefore, the first pulse edge and the second pulse edge alternately appear. The “phase difference δ” is a rotation angle of the motor 11 and the object to be detected 30 between a certain pulse edge and a pulse edge immediately before the certain pulse edge, or a rotation angle of the motor 11 and the object to be detected 30 between a certain pulse edge and a pulse edge immediately after the certain pulse edge. There are two phase differences θ: a first phase difference δ1 and a second phase difference δ2. The sum of the first phase difference δ1 and the second phase difference δ2 is an angular interval between two adjacent pulse edges of the pulse signal and is equal to the central angle θ (θ=δ1+δ2). The phase difference δ is larger than 0 degrees and smaller than the central angle θ (0°<δ<θ).

In FIG. 5, for convenience of description of the phase difference δ, unlike FIG. 4, the first detection element 41 is at the 12:00 position together with the boundary Q1, and the first pulse edge appears. The second detection element 42 is shifted from the first detection element 41 by an arrangement angle difference φ around the central axis A11.

The arrangement angle difference φ can be defined as a value obtained by multiplying the central angle θ by a non-integer coefficient. When an integer part of the coefficient is a and a fractional part thereof is b, the arrangement angle difference φ is expressed by an expression: φ=(a+b)θ. If the arrangement angle difference φ is a non-integral multiple of the central angle θ, when the first detection element 41 faces the boundary Q1, the second detection element 42 is located between two boundaries Q2 and Q3 adjacent in the circumferential direction. Here, among the two boundaries Q2 and Q3, a side close to the first detection element 41 is referred to as a “proximal boundary Q2”, and a side far from the first detection element 41 is referred to as a “distal boundary Q3”.

The angle between the first detection element 41 and the proximal boundary Q2 corresponds to the product of the integer part a and the central angle θ. The first phase difference δ1 is an angle between the proximal boundary Q2 and the second detection element 42, and corresponds to a product of the fractional part b and the central angle θ (δ1=bθ). The sum of these two angles corresponds to the angle between the first detection element 41 and the second detection element 42, that is, the arrangement angle difference φ(aθ+bθ=φ). The second phase difference δ2 is an angle between the second detection element 42 and the distal boundary Q3, and corresponds to a value obtained by subtracting the first phase difference δ1 from the central angle θ (δ2=θ−δ1=(1−b)θ).

If the arrangement angle difference φ is an even multiple of the central angle θ (a in the above equation is an even number and b is zero), the second pulse signal is completely synchronized with the first pulse signal, the timings at which the pulse edges appear coincide with each other, and the directions in which the signal levels are switched coincide with each other. When the arrangement angle difference φ is an odd multiple of the central angle θ (a in the above equation is an odd number and b is zero), the direction in which the signal level is switched is opposite, but the timing at which the pulse edge appears coincides with each other. As described above, when the arrangement angle difference φ is an integral multiple of the central angle θ, there is no phase difference (φ≠aθ).

When the arrangement angle difference φ is defined as a minor angle (0°<φ<180°), the integer part a is an integer less than the number of pairs p (a<p). When the integer part a is 0, the arrangement angle difference φ is less than the central angle θ (φ=bθ, 0°<φ<θ), and the first detection element 41 and the second detection element 42 physically approach each other on the circuit board 40. For convenience of mounting on the circuit board 40, the integer part a is preferably an integer of 1 or more (1≤a<p). That is, the arrangement angle difference φ is preferably larger than the central angle θ (φ≤θ).

If the fractional part b is a value close to 0 or 1, the two pulse signals are almost synchronized rather than having a phase difference δ. In order to significantly generate the phase difference δ, the fractional part b preferably satisfies, for example, ⅓≤b≤⅔. That is, the phase difference δ (the first phase difference δ1 and the second phase difference δ2) is preferably within a range of ⅓ times the central angle θ to ⅔ times the central angle θ.

FIG. 6A illustrates the first pulse signal and the second pulse signal output from the rotation sensor 12 when the motor 11 and the object to be detected 30 illustrated in FIG. 5 rotate at a constant speed in the counterclockwise direction R1. In the case of this rotation direction, the first rising edge E1u appears when the first detection element 41 faces the boundary Q1. Thereafter, when the object to be detected 30 rotates by the second phase difference δ2, the second detection element 42 faces the boundary Q3, and the second rising edge E2u appears. Thereafter, when the object to be detected 30 rotates by the first phase difference δ1, the first detection element 41 faces the boundary Q2, and the first falling edge E1d appears. Thereafter, similarly to this, each time the object to be detected 30 alternately rotates by the angle of the first phase difference δ1 or the second phase difference δ2, the pulse edge repeatedly appears in the order of the first rising edge E1u, the second rising edge E2u, the first falling edge E1d, the second falling edge E2d, and the first rising edge E1u . . .

FIG. 6B illustrates the first pulse signal and the second pulse signal output from the rotation sensor 12 when the motor 11 and the object to be detected 30 illustrated in FIG. 5 rotate at a constant speed in the clockwise direction R2. In the case of this rotation direction, the first falling edge E1d appears when the first detection element 41 faces the boundary Q1. Thereafter, when the object to be detected 30 rotates by the first phase difference δ1, the second detection element 42 faces the boundary Q2, and the second rising edge E2u appears. Thereafter, when the object to be detected 30 rotates by the second phase difference δ2, the first detection element 41 faces the boundary Q4, and the first rising edge E1u appears. Thereafter, similarly to this, each time the object to be detected 30 alternately rotates by the angle of the second phase difference δ2 or the first phase difference δ1, the pulse edge repeatedly appears in the order of the first rising edge E1u, the second falling edge E2d, the first falling edge E1d, the second rising edge E2u, and the first rising edge E1u . . .

The appearance order of the four types of pulse edges (First rising edge E1u, first falling edge E1d, second rising edge E2u, and second falling edge E2d) varies depending on the rotation direction of the object to be detected 30 and the motor 11. Conversely, the rotation direction can be determined based on the difference in the appearance order. This determination cannot be made when the arrangement angle difference φ is an integral multiple of the central angle θ.

In addition, whether the phase difference δ from the appearance of the second pulse edge to the appearance of the first pulse edge is the first phase difference δ1 or the second phase difference δ2 differs depending on the rotation direction. The same applies to the phase difference δ from the appearance of the first pulse edge to the appearance of the second pulse edge.

When the fractional part b is 0.5, the first phase difference δ1 and the second phase difference δ2 are equal at a half value of the central angle θ (δ1=δ2=θ/2). The phase difference δ from the appearance of the second pulse edge to the appearance of the first pulse edge, and the phase difference δ from the appearance of the first pulse edge to the appearance of the second pulse edge are unified to a half value of the central angle θ regardless of the rotation direction. Since there is no need to distinguish between the first phase difference δ1 and the second phase difference δ2, the process of updating the opening/closing speed to be described later can be simplified (see the modification).

For example, when the number of poles P is 4, the integer part a is 1, and the arrangement angle difference φ can be set within a range of 90 degrees to 180 degrees (90°<φ<180°). Accordingly, convenience of implementation is achieved. The arrangement angle difference φ is preferably within a range of 120 degrees to 150 degrees (120°≤φ≤150°). As a result, the phase difference δ is significantly generated (30°≤δ≤60°). When the arrangement angle difference φ is 135 degrees (φ=135°), the phase difference δ is equalized (δ1=δ2=45°).

For example, when the number of poles P is 6, the integer part a can be set to 1 or 2, and the arrangement angle difference φ can be set within a range of 60 degrees to 120 degrees or within a range of 120 degrees to 180 degrees (60°<φ<120°, 120°<φ<180°). The arrangement angle difference φ is preferably in the range of 80° to 100°, or in the range of 140° to 160° (80°≤φ≤100°, 140°≤φ≤160°), and the phase difference δ is generated significantly (20°≤δ≤40°). When the arrangement angle difference φ is 90 degrees or 150 degrees (φ=90°, 150°), the phase difference δ is equalized (δ1=δ2=30°).

Returning to FIG. 2, the controller 20 includes, for example, a central processing unit (CPU) or a micro processing unit (MPU) that realizes a predetermined function in cooperation with software. Controller 20 may be configured by a hardware circuit such as a dedicated electronic circuit designed to realize a predetermined function or a reconfigurable electronic circuit, or may be configured by various semiconductor integrated circuits. Examples of the various semiconductor integrated circuits include a microcomputer, a digital signal processor (DSP), a field programmable gate array (FPGA), and an application specific integrated circuit (ASIC), in addition to a CPU and an MPU. Furthermore, the controller 20 may include a storage device such as a random access memory (RAM) and a read only memory (ROM).

The controller 20 includes a storage unit 21, an input unit 22, a target value setting unit 23, an edge detection unit 24, a speed update unit 25, and a motor control unit 26.

The storage unit 21 can be realized by the above-described storage device. The storage unit 21 temporarily or permanently stores a program for controlling the opening/closing operation of the opening/closing body 5 and information used for the program.

The input unit 22 is connected to the rotation sensor 12 and the start command output unit 13. The input unit 22 acquires pulse signals (a first pulse signal and a second pulse signal) output from the rotation sensor 12. The input unit 22 acquires the start command output from the start command output unit 13.

When the start command is acquired by the input unit 22, the target value setting unit 23 sets the target value Vs of the opening/closing speed of the opening/closing body 5. The target value setting unit 23 sets the target value Vs with reference to a map or a table stored in advance in the storage unit 21.

The edge detection unit 24 detects a pulse edge of the pulse signal acquired by the input unit 22. The edge detection unit 24 detects a first rising edge E1u and a first falling edge E1d of the first pulse signal and a second rising edge E2u and a second falling edge E2d of the second pulse signal as pulse edges of the pulse signals. When the pulse edge is detected by the edge detection unit 24, the storage unit 21 temporarily stores the timing at which the pulse edge is detected.

When the start command and the pulse signal are acquired by the input unit 22, the speed update unit 25 measures the opening/closing speed of the opening/closing body 5 based on at least one of the first pulse signal and the second pulse signal at a predetermined update timing, and updates the measured value Vm of the opening/closing speed. The speed update unit 25 includes a timing setting unit 25a, a cycle calculation unit 25b, and a speed calculation unit 25c. Details will be described later.

The motor control unit 26 controls the motor 11 according to the updated opening/closing speed. Specifically, every time the opening/closing speed is updated by the speed update unit 25, the motor control unit 26 executes feedback control so that the measured value Vm of the opening/closing speed of the opening/closing body 5 matches the target value Vs. For example, the motor control unit 26 changes the operation command value for the motor 11 based on the deviation between the measured value Vm and the target value Vs. As the operation command value, a current value or a duty ratio of the current supplied to the motor 11 can be exemplified. Thus, the update timing of the opening/closing speed is also the change timing of the operation command value.

Note that the “opening/closing speed of the opening/closing body 5” to be controlled is not limited to the displacement speed (For example, the rotation speed (rad/s or deg/s) of the back door) of the opening/closing body 5 itself, and may be another speed that can be associated with the displacement speed from the viewpoint of geometry and mechanics. Examples of such other speeds include the rotational speed of the motor 11 (rps, rad/s, or deg/s) and the operation speed of the drive mechanism 6 (For example, the expansion/contraction speed (mm/s) of the spindle drive mechanism). In the present embodiment, the target value setting unit 23 sets the target value Vs of the rotation speed (rps) of the motor 11 as an example of the “opening/closing speed of the opening/closing body 5”. Similarly, the speed update unit 25 derives the measured value Vm of the rotation speed (rps) of the motor 11 as an example of the “opening/closing speed of the opening/closing body 5”.

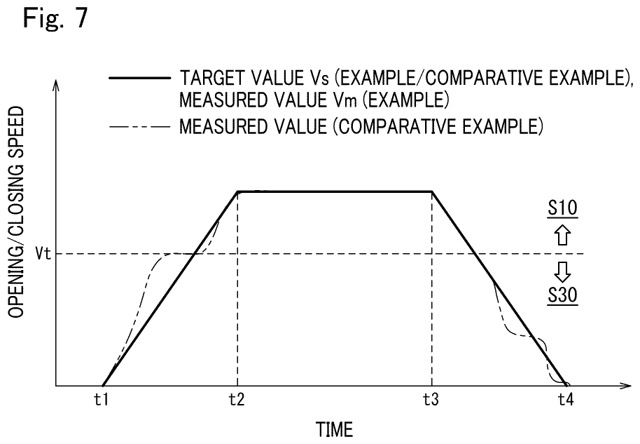

Referring to FIG. 7, the target value Vs is variably set according to the time elapsed from the control start time point t1. The target value Vs gradually increases from the zero value during the cycle from the control start time point t1 to the first intermediate time point t2. The target value Vs is maintained at a constant value during a cycle from the first intermediate time point t2 to the second intermediate time point t3. The target value Vs gradually decreases to a zero value during a cycle from the second intermediate time point t3 to the control end time point t4.

As indicated by the two-dot chain line, in a case where the update timing (the change timing of the operation command value) is synchronized only with the pulse edge of the first pulse signal, there is a possibility that the update frequency decreases and the measured value Vm does not satisfactorily follow the target value Vs when the opening/closing speed is low. Therefore, in the present embodiment, when the opening/closing speed is less than the predetermined threshold Vt, more update timings are secured. This improves the control accuracy at low speed. The opening/closing speed to be compared with the threshold Vt may be the measured value Vm or the target value Vs.

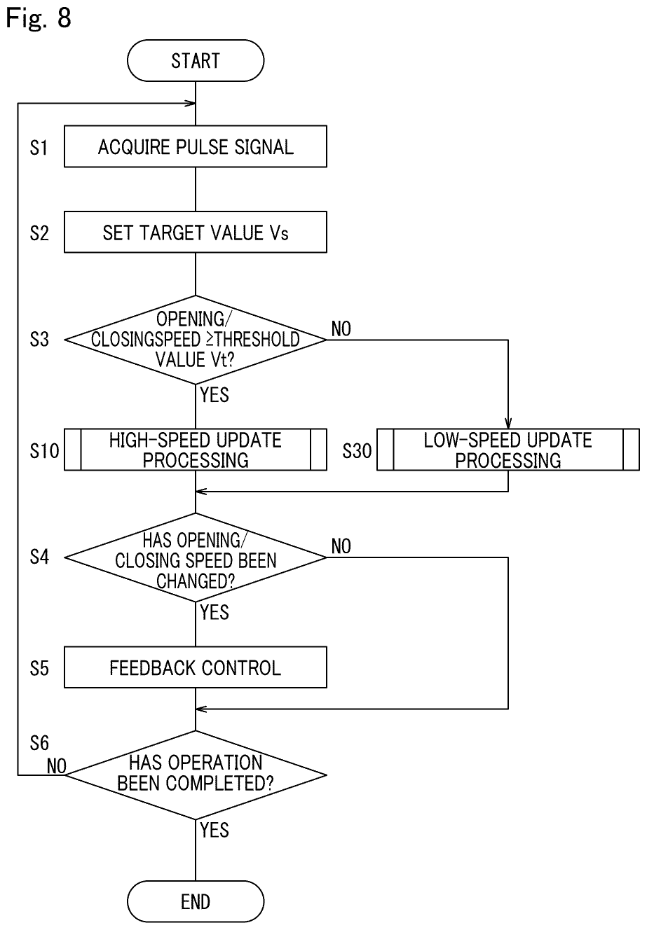

Next, processing executed by the controller 20 will be described with reference to FIGS. 8 to 12. The flow illustrated in FIGS. 8 to 10 starts when the input unit 22 acquires the start command, and is repeated at predetermined control intervals (For example, 10 milliseconds) until the operation of the opening/closing body 5 is completed. In the present embodiment, a case where the first phase difference δ1 and the second phase difference δ2 have values different from each other will be exemplified. Unless otherwise specified, the number of poles P is four.

Referring to FIG. 8, the input unit 22 acquires pulse signals sequentially output from the rotation sensor 12 (step S1). The target value setting unit 23 refers to the map stored in the storage unit 21 and sets the target value Vs of the opening/closing speed according to the elapsed time from the control start time point t1 (step S2). The speed update unit 25 determines whether the opening/closing speed is equal to or higher than the threshold Vt (step S3). When the opening/closing speed is equal to or higher than the threshold Vt (S3: YES), the speed update unit 25 executes update processing at a high speed (S10). If the opening/closing speed is less than the threshold Vt (S3: NO), the speed update unit 25 executes update processing at low speed (S30).

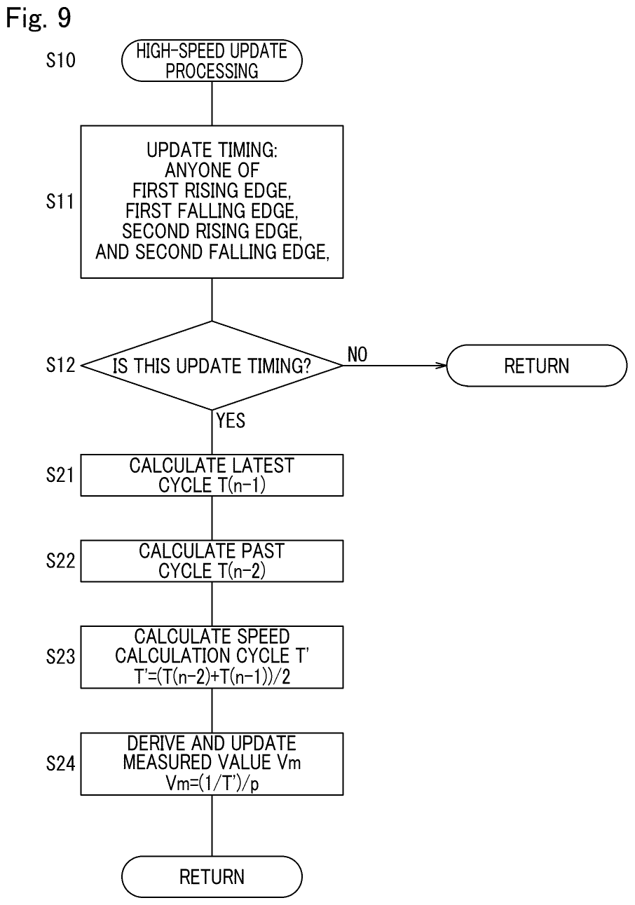

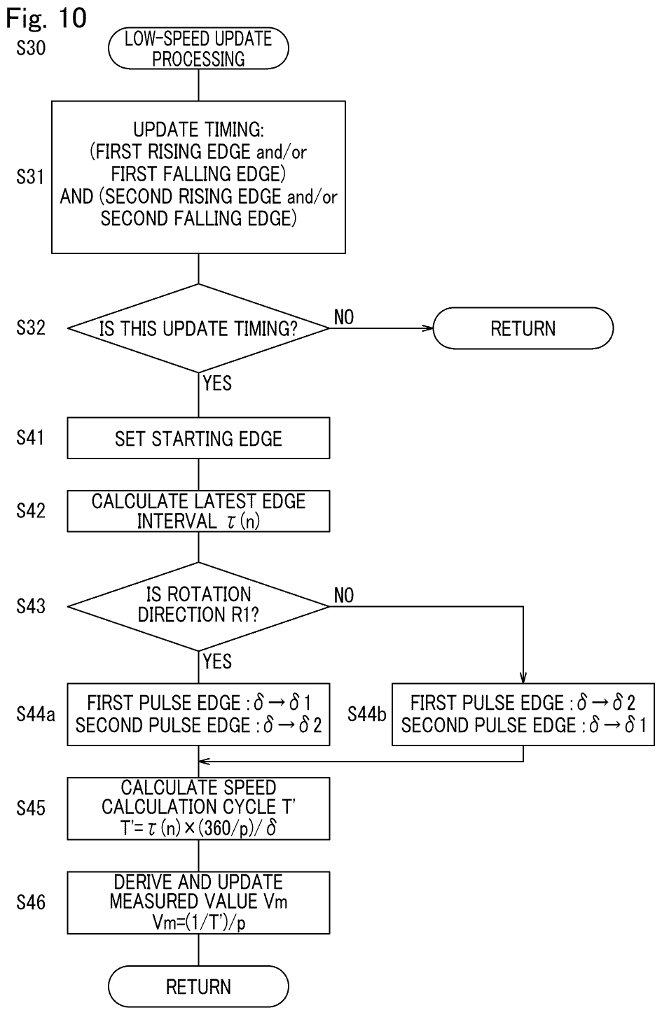

In both the update processing at high speed (S10) illustrated in FIG. 9 and the update processing at low speed (S30) illustrated in FIG. 10, if the current time is the update timing, the speed update unit 25 measures the opening/closing speed, updates the measured value Vm of the opening/closing speed, and then returns to the flow illustrated in FIG. 8. If the current time is outside the update timing, the flow returns to the flow illustrated in FIG. 8 without updating the opening/closing speed by the speed update unit 25.

When the opening/closing speed is updated (S4: YES), the motor control unit 26 executes feedback control for changing the operation command value of the motor 11 based on the deviation between the measured value Vm and the target value Vs updated this time (step S5).

Next, the controller 20 determines whether or not the operation of the opening/closing body 5 has been completed (step S6). When the operation of the opening/closing body 5 is not completed (S6: NO), the process returns to step S1, and the process is repeated. If the opening/closing speed has not been updated (S4: NO), step S5 is skipped, and the process proceeds to step S6. When the operation of the opening/closing body 5 is completed (S6: YES), the process ends.

The target value Vs and the measured value Vm to follow the target value Vs gradually increase from the zero value, are maintained constant at a relatively high speed, and gradually decrease to the zero value in the cycle from the start of the operation to the completion of the operation. In response to this, first, the update processing at a low speed (S30) is executed, next, the update processing at a high speed (S10) is executed, and finally, the update processing at a low speed (S30) is executed again.

The update processing at high speed (S10) and the update processing at low speed (S30) will be described below in this order.

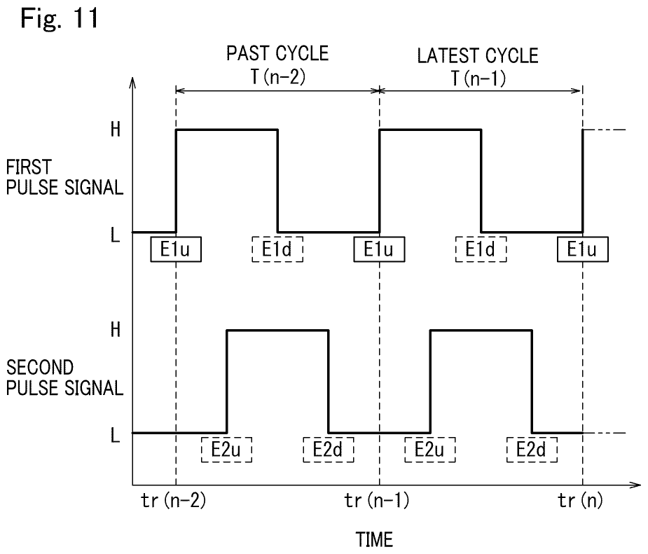

Referring to FIGS. 9 and 11, in the update processing at high speed (S10), the speed update unit 25 executes “one pulse update processing” in which only one of the first pulse signal and the second pulse signal is referred to in order to measure and update the opening/closing speed. The update processing includes a timing setting process of setting an update timing and a measurement process of measuring an opening/closing speed at the set update timing. In the present embodiment, in the update processing at high speed (S10), the one-pulse method is applied to both the timing setting processing and the measurement processing.

First, the speed update unit 25 executes a one-pulse timing setting process that refers only to the rising edge or the falling edge of the first pulse signal or the second pulse signal for setting the update timing.

Specifically, the timing setting unit 25a sets the detection timing of any one of the four types of pulse edges (First rising edge E1u, first falling edge E1d, second rising edge E2u, and second falling edge E2d) as the update timing (step S11). In the present embodiment, as a simple example, the detection timing of the first rising edge E1u is set as the update timing.

Next, the edge detection unit 24 determines whether or not the first rising edge E1u is detected in the current processing flow (step S12). That is, the edge detection unit 24 determines whether the current time point is the update timing. If the current time is not the update timing (S12: NO), the process returns to the flow illustrated in FIG. 8, skips step S5, and proceeds to step S6.

If the current time is the update timing (S12: YES), the speed update unit 25 executes one-pulse measurement processing of measuring the opening/closing speed with reference to only one of the first pulse signal and the second pulse signal. In the present embodiment, the first pulse signal is referred to in the timing setting process, and the first pulse signal is also referred to in the measurement process.

Specifically, the cycle calculation unit 25b calculates the latest cycle T(n−1) (step S21). The latest cycle T(n−1) is a time interval (seconds) from the previous update timing tr(n−1) to the latest update timing tr(n).

Next, the cycle calculation unit 25b reads the past cycle T(n−2) from the storage unit 21 (step S22). The past cycle T(n−2) is a time interval (seconds) from the update timing tr(n−2), which is the second before, to the previous update timing tr(n−1), and is a cycle T immediately before the latest cycle T(n−1). The past cycle T(n−2) is the latest cycle T(n−1) calculated at the previous update timing tr(n−1) and is stored in the storage unit 21. Therefore, the cycle calculation unit 25b does not need to recalculate the past cycle T(n−2).

Next, the cycle calculation unit 25b calculates a speed calculation cycle T′ (step S23). The speed calculation cycle T′ is an average value of the latest cycle T(n−1) and the past cycle T(n−2) (T′=(T(n−1)+T(n−2)/2)). The average value may be calculated by a weighted average obtained by increasing the weighting of the latest cycle T(n−1). The average value is not limited to the arithmetic mean, and may be calculated by other methods such as geometric mean.

Next, the speed calculation unit 25c derives the measured value Vm of the opening/closing speed based on the speed calculation cycle T′ (step S24). Specifically, the measured value Vm is calculated as a value obtained by dividing the reciprocal of the speed calculation cycle T′ by the number of pairs p (Vm=(1/T′)/p). As described above, the number of pairs p is equal to the number of cycles corresponding to one rotation of the motor 11.

The speed calculation cycle T′ is a time (seconds) required for the motor 11 to rotate by a rotation angle corresponding to a value twice the central angle θ, that is, a value obtained by dividing 360 degrees by the number of pairs p near the current point of time. By multiplying the speed calculation cycle T′ by the number of pairs p, it is possible to estimate the time (seconds) required for the motor 11 to make one rotation around the current point of time. The measured value Vm is derived as a reciprocal of the estimated value (T′×p), that is, the number of rotations (rps or Hz) of the motor 11 per unit time near the current point.

When the measured value Vm is derived in this manner, the speed update unit 25 updates the measured value Vm. Returning to the flow illustrated in FIG. 8, feedback control is executed using the updated measured value Vm (step S5).

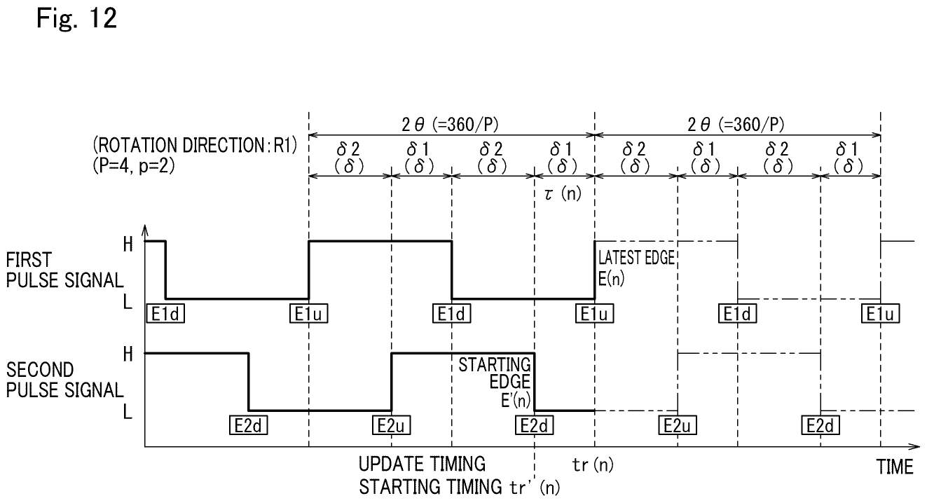

Next, referring to FIGS. 10 and 12, in the update processing at a low speed (S30), the speed update unit 25 executes “two-pulse update processing” that refers to both the first pulse signal and the second pulse signal in order to measure and update the opening/closing speed. In the present embodiment, the two-pulse method is applied to both the timing setting process and the measurement process in the update processing at low speed (S30).

The speed update unit 25 refers to both the first pulse signal and the second pulse signal to set the update timing. Specifically, the timing setting unit 25a sets the detection timing of at least one of the first rising edge E1u and the first falling edge E1d and the detection timing of at least one of the second rising edge E2u and the second falling edge E2d as the update timing (step S31). In the present embodiment, as a simple example, detection timings of all four of the first rising edge E1u, the first falling edge E1d, the second rising edge E2u, and the second falling edge E2d are set as update timings.

Next, the edge detection unit 24 determines whether any one of the four pulse edges has been detected in the current processing flow (step S32). That is, the edge detection unit 24 determines whether or not the current time point is the update timing tr(n). If the current time is not the update timing tr(n) (S32: NO), the process returns to the flow illustrated in FIG. 8, skips step S5, and proceeds to step S6.

When the current time is the update timing tr(n) (S32: YES), the speed update unit 25 measures the opening/closing speed based on both the first pulse signal and the second pulse signal. Here, the pulse edge detected at the current time point, that is, the latest update timing tr(n) is referred to as a “latest edge E(n)”.

Specifically, the cycle calculation unit 25b sets the starting edge E′(n) (step S41) and calculates the latest edge interval τ(n) (step S42). The latest edge interval τ(n) is a time interval from the timing (Hereinafter, the starting timing tr′(n)) at which the starting edge E′(n) is detected to the current time point (In other words, the timing at which the latest edge is detected, in other words, the latest update timing tr(n)).

The starting timing tr′(n) is a starting point of the latest edge interval τ(n). The starting edge E′(n) is a pulse edge detected in the past, by a predetermined number of edges, from the latest edge E(n) among the four types of pulse edges sequentially detected by the edge detection unit 24. The predetermined number of edges is, for example, one. In that case, the starting edge E′(n) is a pulse edge detected immediately before the latest edge E(n).

When the predetermined number of edges is 1, the latest edge interval τ(n) is a time required for the motor 11 to rotate by a rotation angle corresponding to the phase difference δ between the latest edge E(n) and the pulse edge appearing immediately before the latest edge E(n). When the fractional part b is not 0.5, the phase difference δ becomes one of the first phase difference δ1 and the second phase difference δ2 which are different values from each other, and which is applied is determined according to the rotation direction and according to whether the latest edge E(n) is the first pulse edge or the second pulse edge.

Therefore, the cycle calculation unit 25b sets the phase difference δ corresponding to the latest edge E(n) to the first phase difference δ1 or the second phase difference δ2 according to the rotation direction of the motor 11 and whether or not the latest edge E(n) is the first pulse edge (Steps S43, S44a, and S44b).

For example, when the rotation direction is the counterclockwise direction R1 in FIG. 5 (S43: YES), the first pulse edge is associated with the first phase difference δ1, while the second pulse edge is associated with the second phase difference δ2 (step S44a). When the rotation direction is the clockwise direction R2 in FIG. 5 (S43: NO), the first pulse edge is associated with the second phase difference δ2, while the second pulse edge is associated with the first phase difference δ1 (step S44b).

Next, the cycle calculation unit 25b calculates a speed calculation cycle T′ (step S45). The speed calculation cycle T′is a cycle T (Time required for the motor 11 to rotate by a rotation angle corresponding to a double value of the central angle θ, that is, a value obtained by dividing 360 degrees by the number of pairs p) estimated based on the ratio between the phase difference δ and the latest edge interval τ(n). The speed calculation cycle T′ is obtained by multiplying the latest edge interval τ(n) by a value obtained by dividing the rotation angle by the phase difference δ (T′=τ(n)×(360/p)/δ). When dividing by the phase difference δ, the first phase difference δ1 or the second phase difference δ2 set in steps S44a and S44b is applied to the phase difference δ.

Next, the speed calculation unit 25c derives the measured value Vm of the opening/closing speed based on the speed calculation cycle T′ in the same manner as the one-pulse method (step S46). The measured value Vm is calculated as a value obtained by dividing the reciprocal of the speed calculation cycle T′ by the number of pairs p (Vm=(1/T′)/p). The measured value Vm is derived as the number of revolutions (rps or Hz) of the motor 11 per unit time.

When the measured value Vm is derived in this manner, the speed update unit 25 updates the measured value Vm. Returning to the flow illustrated in FIG. 8, feedback control is executed using the updated measured value Vm (step S5).

In the opening/closing body control device 10 having the above configuration, the rotation sensor 12 can output the first pulse signal and the second pulse signal having the phase difference δ. The speed update unit 25 of the controller 20 executes a two-pulse update processing of referring to both the first pulse signal and the second pulse signal in the update processing of measuring and updating the opening/closing speed. In particular, in the timing setting process, the speed update unit 25 sets, as the update timing, the timing at which at least one of the first rising edge E1u and the first falling edge E1d is detected and the timing at which at least one of the second rising edge E2u and the second falling edge E2d is detected. When the opening/closing speed of the opening/closing body 5 is less than the threshold Vt, the speed update unit 25 executes the two-pulse update processing.

In the two-pulse update processing, the update timing for measuring and updating the opening/closing speed is synchronized with the detection timing of the pulse edge of the first pulse signal and the detection timing of the pulse edge of the second pulse signal. The measurement frequency of the opening/closing speed is improved as compared with the case where the opening/closing speed is updated in sync with only the pulse edge of the single pulse signal. Therefore, as illustrated in FIG. 7, the measured value Vm favorably follows the target value Vs, and the control accuracy is improved.

In the present embodiment, when the opening/closing speed is less than the threshold Vt, the target value Vs gradually increases or decreases, and the opening/closing body 5 accelerates or decelerates. The control accuracy of the acceleration and deceleration of the opening/closing body 5 can be improved, and the opening/closing body 5 can be smoothly operated according to the control target.

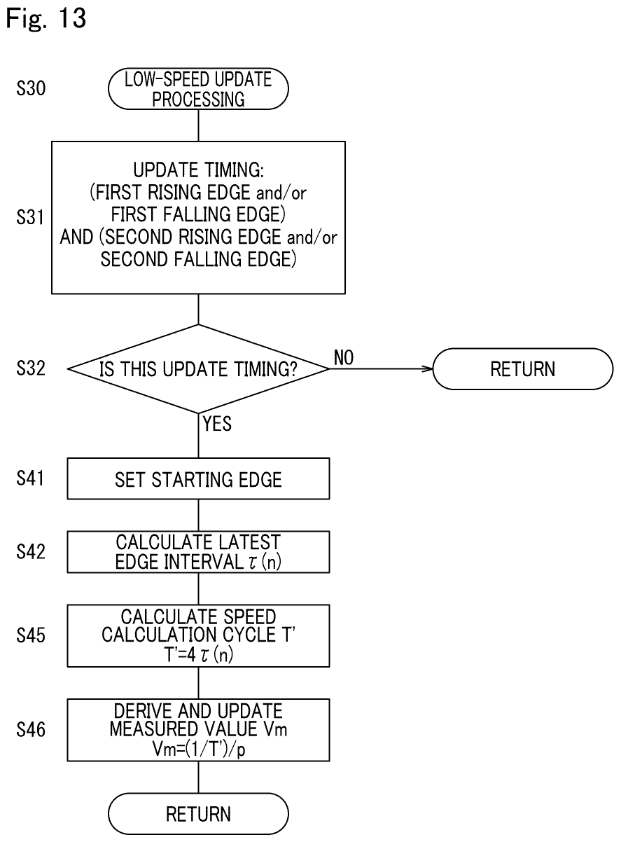

FIG. 13 is a flowchart of update processing at a low speed (S30) according to a modification. When the fractional part b is 0.5, regardless of whether the latest edge E(n) is the first pulse edge or the second pulse edge, and regardless of the rotation direction of the motor 11, the angular interval between the latest edge E(n) and the immediately preceding pulse edge is a half value of the central angle θ (δ=δ1=δ2=θ/2).

Therefore, in this modification, steps S43, S44a, and S44b are omitted (see also FIG. 10). In step S45, the equation for calculating the speed calculation cycle T′ can be simplified. A quadruple value of the equalized phase difference δ corresponds to a rotation angle of one cycle. Therefore, the speed calculation cycle T′ can be derived by simply multiplying the latest edge interval τ(n) by four (T′=4τ(n)).

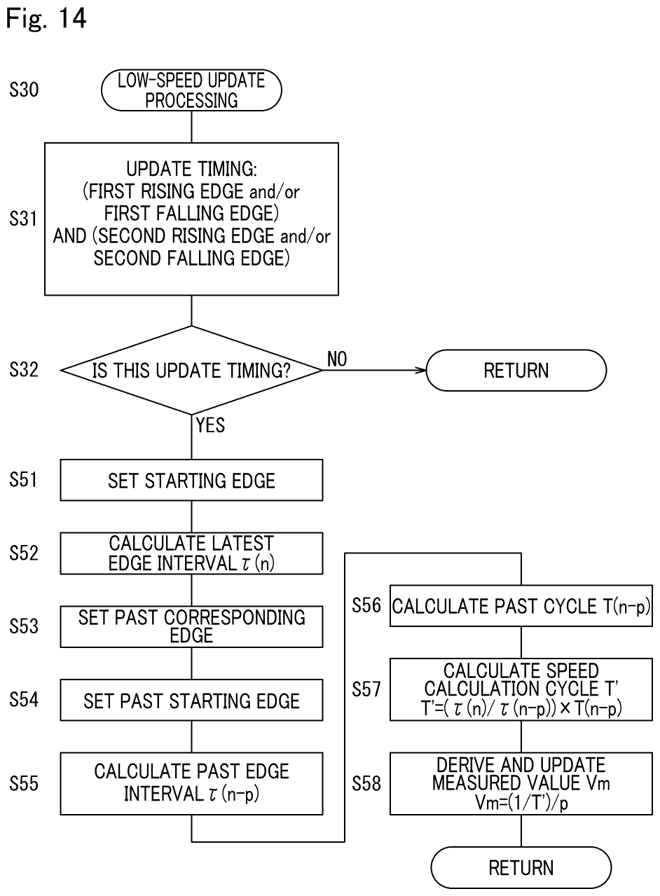

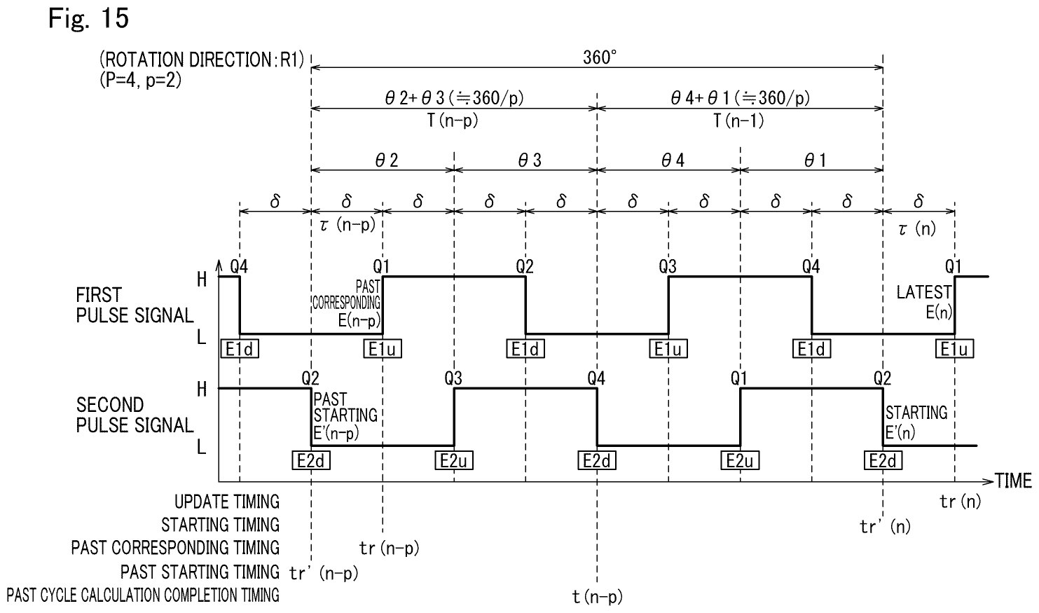

Next, a second embodiment will be described with reference to FIGS. 14 to 16. Also in the present embodiment, the update processing is different between the low speed and the high speed. In the update processing at a low speed, the two-pulse method is applied to both the timing setting processing and the measurement processing. The content of the measurement processing is different from that of the first embodiment. Hereinafter, the second embodiment will be described focusing on a difference from the first embodiment.

As illustrated in FIG. 14, in the measurement process, the cycle calculation unit 25b sets the starting edge E′(n) in the same manner as in the first embodiment (See steps S41 and S42 in FIG. 10) (step S51), and calculates the latest edge interval τ(n) (step S52). Also in the present embodiment, the starting edge E′(n) is a pulse edge detected in the past, by a predetermined number of edges, from the latest edge E(n). As an example, the predetermined number of edges is one, and the starting edge E′(n) is a previous pulse edge of the latest edge E(n).

Next, the cycle calculation unit 25b sets the past corresponding edge E(n−p) (step S53), sets the past starting edge E′(n−p) (step S54), and calculates the past edge interval τ(n−p) (step S55). The past corresponding edge E(n−p) is a pulse edge detected in the past, by a predetermined number of cycles, from the latest update timing. The predetermined number of cycles is, for example, the same as the number of cycles corresponding to one rotation of the motor 11, that is, the number of pairs p. For example, when the number of poles P is four, the predetermined number of cycles is two.

Next, the cycle calculation unit 25b calculates the past cycle T(n−p) (step S56). For example, the past cycle T(n−p) is a time required for the motor 11 to rotate by a rotation angle corresponding to one cycle from the past starting edge E′(n−p). The cycle calculation unit 25b reads the detection timing tr′(n−p) of the past starting edge E′(n−p) and the detection timing (past cycle calculation completion timing T(n−p)) of the pulse edge one cycle after the detection timing tr′(n−p) from the storage unit 21, and calculates the past cycle T(n−p) from the two detection timing differences.

Next, the cycle calculation unit 25b calculates a speed calculation cycle T′ (step S57). In the present embodiment, the speed calculation cycle T′ is calculated by multiplying the ratio (τ(n)/τ(n−p)) of the latest edge interval τ(n) to the past edge interval τ(n−p) by the past cycle T(n−p) (T′=(τ(n)/τ(n−p))×T(n−p)).

Next, the speed calculation unit 25c derives the measured value Vm of the opening/closing speed based on the speed calculation cycle T′ (step S58). The measured value Vm is calculated as a value obtained by dividing the reciprocal of the speed calculation cycle T′ by the number of pairs p (Vm=(1/T′)/p). The measured value Vm is derived as the number of revolutions (rps or Hz) of the motor 11 per unit time.

As described above, the past starting edge E′(n−p) is a pulse edge detected in the past, by the predetermined number of edges, from the past corresponding edge E(n−p). The predetermined number of edges is the same as the number of edges considered at the time of setting the starting edge E′(n). In this example, since the starting edge E′(n) is set to the previous pulse edge of the latest edge E(n), the past starting edge E′(n−p) is also set to the previous pulse edge of the past corresponding edge E(n−p).

The past edge interval τ(n−p) is a time interval (seconds) from the past starting timing tr′(n−p) to the past correspondence timing tr(n−p).

The past corresponding edge E(n−p) is a pulse edge detected in the past by one rotation of the motor 11 from the detection timing of the latest edge E(n). That is, the latest edge E(n) and the past corresponding edge E(n−p) are pulse edges that appear when the same one of the first detection element 41 and the second detection element 42 faces the same boundary among the boundaries Q1 to Q4 of the plurality of magnetic poles 31-34 provided in the object to be detected 30.

The starting edge E′(n) and the past starting edge E′(n−p) are pulse edges detected in the past, by the same predetermined number of edges, from each of the latest edge E(n) and the past corresponding edge E(n−p). Therefore, the starting edge E′(n) and the past starting edge E′(n−p) are also pulse edges that appear when the same one of the first detection element 41 and the second detection element 42 faces the same boundary among the boundaries Q1 to Q4 of the plurality of magnetic poles 31-34 provided in the object to be detected 30.

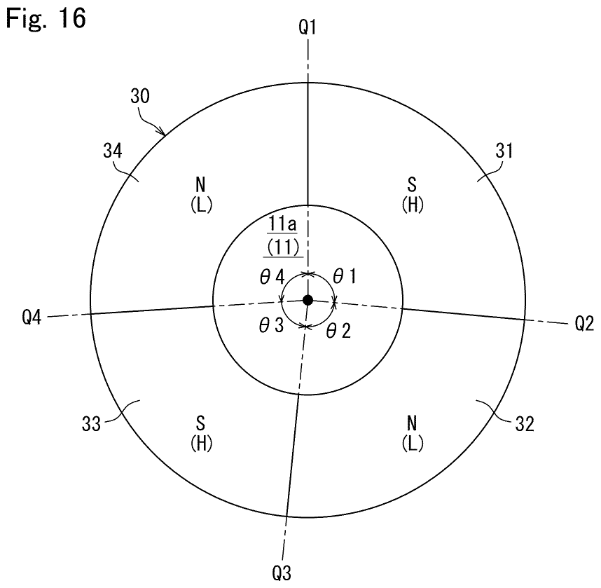

Referring to FIG. 16, ideally, the central angles of the respective magnetic poles 31-34 of the rotation sensor 12 are equal to each other. However, in reality, the central angles θ1, θ2, θ3, and θ4 of the magnetic pole 31-34 vary. As described above, when the past edge interval τ(n−p) is determined, the latest edge interval τ(n) and the past edge interval τ(n−p) are times required for the motor 11 to rotate the same phase portion in the object to be detected 30.

The cycle calculation unit 25b calculates the speed calculation cycle T′ by applying the ratio relationship between the past edge interval τ(n−p) and the past cycle T(n−p) to the ratio relationship between the latest edge interval τ(n) and the speed calculation cycle T′. The latest edge interval τ(n) and the past edge interval τ(n−p) are times required for the motor 11 to rotate by the same rotation angle even if the magnetic pole 31-34 of the rotation sensor 12 varies. Therefore, the speed calculation cycle T′, which is the cycle of the pulse signal in the vicinity of the current point, can be accurately estimated from the past cycle T(n−p).

The above configuration can be appropriately changed within the scope of the gist of the present invention.

In each of the above embodiments, the two-pulse measurement processing is performed at all update timings in the update processing at the low speed (S30). However, the one-pulse measurement processing (see FIG. 9) may be executed at some update timings, and the two-pulse measurement processing (See FIGS. 10, 13, and 14) may be executed at the remaining update timings.

In each of the above embodiments, the two-pulse timing setting process is performed in the update processing at the low speed (S30), and the one-pulse timing setting process is performed in the update processing at the high speed (S10). However, the two-pulse timing setting process may also be performed in the update processing at high speed (S10).

In some of the measurement processes exemplified above, the detection timing of the past pulse edge, the past edge interval, or the past cycle is used to calculate the speed calculation cycle T′. In a case where such past data does not exist at the beginning of the control start, exception processing is appropriately performed.

The opening 2 may be provided on a side portion of the vehicle body 1 to open the passenger compartment, and the opening/closing body 5 may be a side door. The opening 2 may open a cargo compartment or an engine room, and the opening/closing body 5 may be a trunk lid or a hood in addition to a door. The rotation axis of the opening/closing body 5 may extend in the vehicle height direction in addition to the vehicle width direction. Displacement of the opening/closing body 5 may be realized by sliding in addition to rotation. The drive mechanism 6 is not limited to the spindle drive mechanism, and can be appropriately changed so as to be suitable for the operation of the opening/closing body 5 according to the aspect of the opening 2, the location of the opening/closing body 5, and the displacement aspect of the opening/closing body 5.

What is claimed is:

1. An opening/closing body control device that controls an operation of an opening/closing body that opens and closes an opening of a vehicle body, the opening/closing body control device comprising:
a motor that outputs a rotational driving force for driving the opening/closing body;
a rotation sensor that outputs a first pulse signal and a second pulse signal having a phase difference from the first pulse signal at a cycle corresponding to rotation of the motor;
an edge detection unit that detects a first rising edge and a first falling edge of the first pulse signal and a second rising edge and a second falling edge of the second pulse signal as pulse edges of the pulse signals;
a speed update unit that measures and updates an opening/closing speed of the opening/closing body based on at least one of the first pulse signal and the second pulse signal at a predetermined update timing; and
a motor control unit that controls the motor according to the updated opening/closing speed,
wherein the speed update unit executes two-pulse update processing of setting, as the update timing, a timing at which at least one of the first rising edge and the first falling edge is detected and a timing at which at least one of the second rising edge and the second falling edge is detected.

2. The opening/closing body control device according to claim 1, wherein the speed update unit executes the two-pulse update processing when the opening/closing speed measured by the speed update unit is less than a predetermined value.

3. The opening/closing body control device according to claim 1, wherein
in a case of defining, as a latest edge, the pulse edge detected at the latest update timing,
defining, as a starting edge, a past edge, by a predetermined number of edges, from the latest edge among the pulse edges sequentially detected by the edge detection unit,
defining, as a starting timing, a timing at which the edge detection unit detects the starting edge, and
defining, as a latest edge interval, a time period from the starting timing to the latest update timing,
the speed update unit, at the latest update timing during execution of the two-pulse update processing,
measures the latest edge interval, and
measures the opening/closing speed based on the latest edge interval.

4. The opening/closing body control device according to claim 3, wherein, in a case of defining, as one cycle of the pulse signal, an interval between two adjacent rising edges or two adjacent falling edges in the first pulse signal or the second pulse signal,
defining, as a past corresponding edge, the pulse edge detected at the past update timing, by a predetermined number of cycles, from the latest update timing,
defining, as a past starting edge, a past pulse edge, by the same number of edges, as the predetermined number of edges from the past corresponding edge among the pulse edges sequentially detected by the edge detection unit,
defining, as a past starting timing, a timing at which the past starting edge is detected by the edge detection unit, and
defining, as a past edge interval, a time from the past starting timing to the past update timing,
the speed update unit, at the latest update timing during execution of the two-pulse update processing,
measures the latest edge interval and the past edge interval, and
measures the opening/closing speed based on a ratio of the latest edge interval to the past edge interval.

5. The opening/closing body control device according to claim 4, wherein the predetermined number of cycles is a number of cycles corresponding to one rotation of the motor.

6. The opening/closing body control device according to claim 2, wherein
in a case of defining, as a latest edge, the pulse edge detected at the latest update timing,
defining, as a starting edge, a past edge, by a predetermined number of edges, from the latest edge among the pulse edges sequentially detected by the edge detection unit,
defining, as a starting timing, a timing at which the edge detection unit detects the starting edge, and
defining, as a latest edge interval, a time period from the starting timing to the latest update timing,
the speed update unit, at the latest update timing during execution of the two-pulse update processing,
measures the latest edge interval, and
measures the opening/closing speed based on the latest edge interval.

7. The opening/closing body control device according to claim 6, wherein, in a case of defining, as one cycle of the pulse signal, an interval between two adjacent rising edges or two adjacent falling edges in the first pulse signal or the second pulse signal,
defining, as a past corresponding edge, the pulse edge detected at the past update timing, by a predetermined number of cycles, from the latest update timing,
defining, as a past starting edge, a past pulse edge, by the same number of edges, as the predetermined number of edges from the past corresponding edge among the pulse edges sequentially detected by the edge detection unit,
defining, as a past starting timing, a timing at which the past starting edge is detected by the edge detection unit, and
defining, as a past edge interval, a time from the past starting timing to the past update timing,
the speed update unit, at the latest update timing during execution of the two-pulse update processing,
measures the latest edge interval and the past edge interval, and
measures the opening/closing speed based on a ratio of the latest edge interval to the past edge interval.

8. The opening/closing body control device according to claim 7, wherein the predetermined number of cycles is a number of cycles corresponding to one rotation of the motor.
